(19) United States
(12) Patent Application Publication
(10) Pub. No.: US 2013/0025173 A1
(43) Pub. Date: Jan. 31, 2013

(54) THREE-DIMENSIONAL GREETING CARD AND CARD STAND FOR THE CARD

(71) Applicants: Hiromichi Takenaka, Tokyo (JP); Norio Adachi, Tokyo (JP)

(72) Inventors: Hiromichi Takenaka, Tokyo (JP); Norio Adachi, Tokyo (JP)

(21) Appl. No.: 13/634,661

(22) PCT Filed: Jun. 15, 2010
(86) PCT No.: PCT/JP2010/003960

§ 371 Date: Sep. 13, 2012

(30) Foreign Application Priority Data
Apr. 23, 2010 (JP) 2010-099565

(51) Int. Cl. G09F 1/06; G09F 1/10; G09F 1/00

(52) U.S. Cl. 40/124.02

(57) ABSTRACT

Provided are a three-dimensional greeting card which presents a variety of visualizing changes and a card stand which is suitable for holding and displaying a thick three-dimensional greeting card. The three-dimensional greeting card includes: a back plate part including a light source; a shadow picture projecting sheet part; and an original image sheet part in which a shadow picture forming image is formed, the original image sheet part being interposed between the back plate part and the shadow picture projecting sheet part. The card stand for the three-dimensional greeting card includes a flat card mount body including a cut for forming a pair of bent protruding pieces.

### FIELD OF THE INVENTION

The present invention relates to a three-dimensional greeting card and a card stand for the same.

### BACKGROUND OF THE INVENTION

A greeting card is widely utilized for: celebration of a birthday and entrance into a school or the like; invitation to social gathering and a welcome/farewell party or the like; announcement of opening of a shop and a change of address or the like.

Then, the conventional greeting card generally includes a picture part and a message space part, and is merely a thin card made of paper (see, for example, Patent Document 1). Hence, the conventional greeting card is poor in visualizing changes, and has a flat shape.

### PRIOR ART DOCUMENT

### Patent Document

[Patent Document 1] JP-A-07-52585

### SUMMARY OF THE INVENTION

The present invention has been made in view of the conventional actuality as described above, and therefore is to provide a three-dimensional greeting card which presents a variety of visualizing changes.

In the case of such a thick three-dimensional greeting card, a photo frame or the like cannot be used unlike conventional cases. Hence, the present invention is also to provide a card stand which is suitable for holding and displaying the three-dimensional greeting card.

As a result of various studies for achieving the above-mentioned objects, the inventors of the present invention have found that the use of a shadow picture can bring a greeting card which is extremely innovative and presents a variety of visualizing changes, and thus have completed the three-dimensional greeting card according to the present invention.

The inventors of the present invention have also found that the use of a pair of bent protruding pieces formed in a card mount enables the thick three-dimensional greeting card to be easily held and displayed, and thus have completed the card stand for the three-dimensional greeting card according to the present invention.

That is, in order to achieve the above-mentioned objects, the present invention provides a three-dimensional greeting card including: a back plate part including a light source; a shadow picture projecting sheet part; and an original image sheet part in which a shadow picture forming image is formed, the original image sheet part being interposed between the back plate part and the shadow picture projecting sheet part.

In addition, in order to achieve the above-mentioned objects, the present invention provides a card stand for the three-dimensional greeting card including a flat card mount body including a cut for forming a pair of bent protruding pieces.

According to the three-dimensional greeting card of the present invention, a shadow picture is projected on a front part thereof, and hence a person who receives the greeting card can enjoy innovative visualizing changes which have not been obtained conventionally. In addition, by the use of the card stand for the three-dimensional greeting card according to the present invention, the greeting card can be easily held and displayed by simply forming a pair of the protruding pieces through bending.

### BRIEF DESCRIPTION OF DRAWINGS

FIG. 1 is an explanatory perspective view illustrating a three-dimensional greeting card according to the present invention.

FIG. 2 is an explanatory exploded perspective view schematically illustrating the three-dimensional greeting card according to the present invention.

FIG. 3 is an explanatory cross-sectional view illustrating a picture structure example which is three-dimensionally formed.

FIG. 4 is an explanatory perspective view illustrating a box for housing the three-dimensional greeting card according to the present invention.

FIG. 5 is an explanatory configuration view schematically illustrating a back plate part.

FIG. 6 is an explanatory plan view illustrating a card stand for the three-dimensional greeting card according to the present invention.

FIG. 7 is an explanatory perspective view illustrating a usage example of the card stand for the three-dimensional greeting card according to the present invention.

### DETAILED DESCRIPTION OF THE INVENTION

Hereinafter, an embodiment of the present invention is described with reference to the drawings.

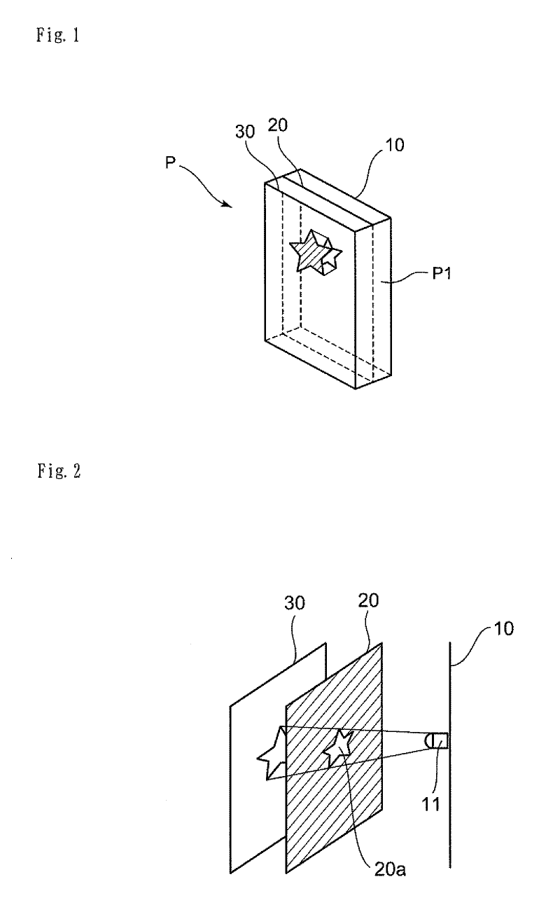

FIG. 1 is an explanatory perspective view illustrating a three-dimensional greeting card according to the present invention, and FIG. 2 is an explanatory exploded perspective view schematically illustrating the same.

In FIG. 1 and FIG. 2, P denotes the three-dimensional greeting card, and a back plate part 10, an original image sheet part 20, and a shadow picture projecting sheet part 30 are set in a side frame P1 such that the original image sheet part 20 is interposed with an appropriate space between the back plate part 10 and the shadow picture projecting sheet part 30.

The back plate part 10 includes a light source 11. For example, a miniature bulb or an LED lamp is used for the light source.

A shadow picture forming image 20a is formed in the original image sheet part 20. A specific method for forming the shadow picture forming image 20a is not particularly limited, and examples thereof include: a method for forming a hole having an appropriate shape in a non-transparent sheet; or a method for drawing an appropriate picture on a transparent sheet.

The material of the shadow picture projecting sheet part 30 may be any material as long as an intended shadow picture can be projected on the material, and examples thereof include paper, cloth, and synthetic resin films or the like.

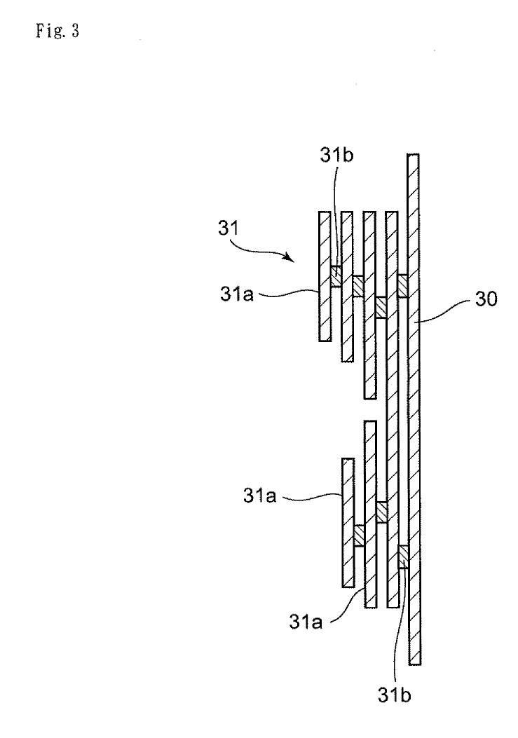

As illustrated in FIG. 3, a picture (so-called Decoupage) 31, which is three-dimensionally formed by stacking and attaching paper pieces 31a with spacers 31b being appropriately interposed therebetween, is further formed and presented on a front surface of the shadow picture projecting sheet part 30. This is desirable for more improvement in decorative features.

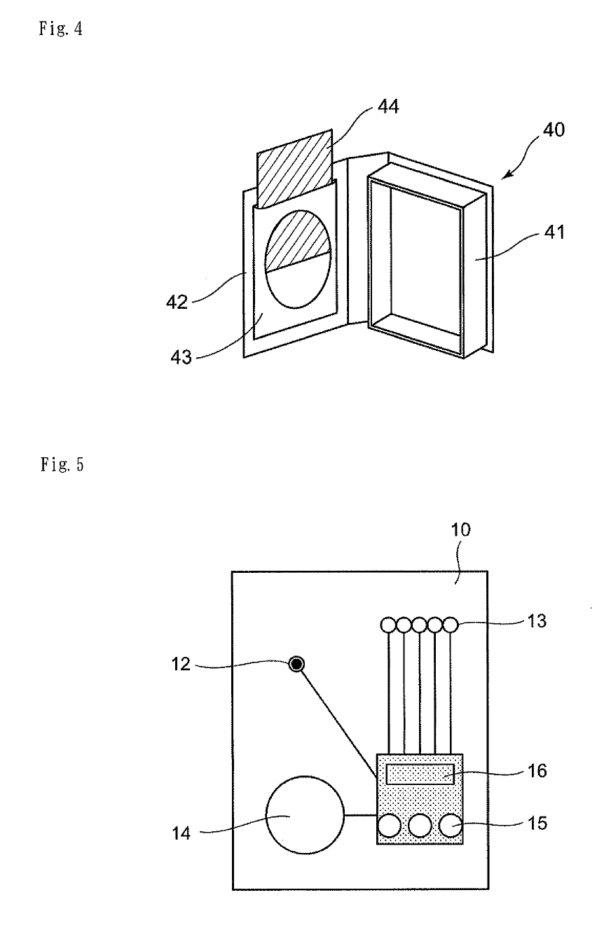

Next, FIG. 4 is an explanatory perspective view illustrating a box for housing the three-dimensional greeting card according to the present invention.

In FIG. 4, 40 denotes the box, and the box 40 includes a housing frame part 41 and a bendable opening/closing cover 42. A pocket part 43 for housing a sheet-like small article 44 such as a message card and a photo is formed on an inner surface of the bendable opening/closing cover 42.

When the three-dimensional greeting card is formed by housing the back plate part 10, the original image sheet part 20, and the shadow picture projecting sheet part 30 in the box 40, the box 40 functions as a protective case. Hence, the thick three-dimensional greeting card can be safely transported and stored, and the three-dimensional greeting card P can be easily appreciated by opening the bendable opening/closing cover 42.

In addition, if a message card, a commemorative photo, or the like is housed in the pocket part 43, the housed article can be sent to a receiver together with the three-dimensional greeting card.

In the three-dimensional greeting card formed by housing the back plate part 10, the original image sheet part 20, and the shadow picture projecting sheet part 30 in the box 40 as described above, the back plate part 10 is provided with means for sensing, when the bendable opening/closing cover 42 is opened, external light to start a blinking operation of a light and also start an operation of sounding an electronic melody. This can bring further pleasure of changes due to light and sound, leading to more improvement in added value as a gift.

The means for activating the light and the electronic sound is simply configured, for example, in the following manner. As illustrated in FIG. 5, a light sensor 12, an LED lamp 13, a loudspeaker 14, a power supply 15, and an IC 16 are arranged on the back plate part 10, and the light sensor 12, the LED lamp 13, and the loudspeaker 14 are connected to the IC 16. Specifically, a button cell or a solar cell is preferably used as the power supply 15, and when the light sensor 12 senses external light, the IC 16 controls a blinking operation of the LED lamp 13 and an electronic melody operation of the loudspeaker 14, using electric power of the power supply 15.

Note that, in the case where the LED lamp 13 is arranged, it is desirable that the original image sheet part 20 and the shadow picture projecting sheet part 30 are transparent or semi-transparent in order to enable the blinking of the LED lamp 13 to be viewed from the outside.

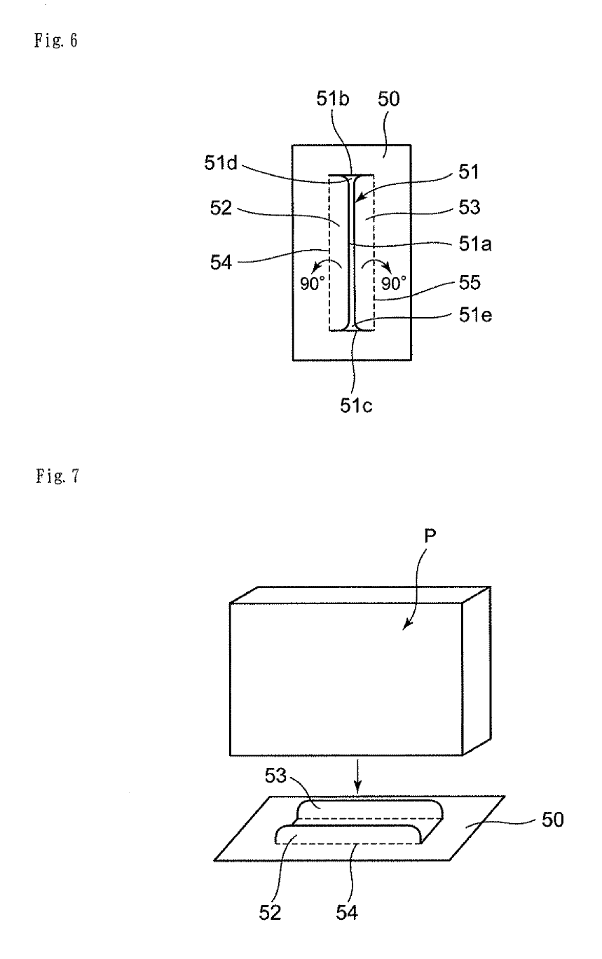

Next, FIG. 6 is an explanatory plan view illustrating a card stand for the three-dimensional greeting card according to the present invention.

In FIG. 6, 50 denotes a flat card mount body, and a cut 51 for forming a pair of bent protruding pieces 52 and 53 is formed in substantially the center of the flat card mount body 50. The cut 51 includes: one long cut 51a; and two short cuts 51b and 51c formed at both ends of the cut 51a, which define a substantially I shape, and portions of the flat card mount body 50 can be upwardly bent along valley fold lines 54 and 55. Partially removed parts 51d and 51e are provided at intersecting portions between the long cut 51a and the short cuts 51b and 51c, whereby both corners of the bent protruding pieces 52 and 53 are rounded. This is preferable for increase in safety.

Note that the material of the flat card mount body 50 may be any material as long as the material is bendable, and examples thereof include paper and synthetic resin or the like.

The portions of the flat card mount body 50 which are surrounded by the cut 51 and the valley fold lines 54 and 55 are upwardly bent, whereby a pair of the bent protruding pieces 52 and 53 can be formed. Then, as illustrated in FIG. 7, the three-dimensional greeting card P is inserted between a pair of the bent protruding pieces 52 and 53 thus formed, whereby the thick three-dimensional greeting card can be stably held and fixed and thus can be appreciated as a standing display.

### Reference Signs List

P: three-dimensional greeting card
P1: side frame
10: back plate part
11: light source
20: original image sheet part
20a: shadow picture forming image
30: shadow picture projecting sheet part
31: three-dimensionally formed picture
31a: paper piece
31b: spacer
40: box
41: housing frame part
42: bendable opening/closing cover
43: pocket part
50: flat card mount body
51: cut
51a: long cut
51b, 51c: short cut
51d, 51e: partially removed part
52, 53: bent protruding piece
54, 55: valley fold line

1. A three-dimensional greeting card comprising:
a back plate part including a light source;
a shadow picture projecting sheet part; and
an original image sheet part in which a shadow picture forming image is formed, the original image sheet part being interposed between the back plate part and the shadow picture projecting sheet part.

2. The three-dimensional greeting card according to claim 1, wherein a picture which is three-dimensionally formed by stacking and attaching paper pieces is presented on a front surface of the shadow picture projecting sheet part.

3. The three-dimensional greeting card according to claim 1, wherein the back plate part, the original image sheet part, and the shadow picture projecting sheet part are housed in a box including a bendable opening/closing cover.

4. The three-dimensional greeting card according to claim 3, wherein the back plate part includes means for sensing, when the bendable opening/closing cover is opened, external light to start a blinking operation of a light and also start an operation of sounding an electronic melody.

5. The three-dimensional greeting card according to claim 4, wherein the means includes a light sensor, an LED lamp, a loudspeaker, a battery, and an IC.

6. The three-dimensional greeting card according to any one of claims 3 to 5, wherein the bendable opening/closing cover includes a pocket part formed on an inner surface thereof, the pocket part serving to house a sheet-like small article.

7. A card stand for the three-dimensional greeting card according to any one of claims 1 to 5, the card stand comprising a flat card mount body including a cut for forming a pair of bent protruding pieces.

8. A card stand for the three-dimensional greeting card according to claim 6, the card stand comprising a flat card mount body including a cut for forming a pair of bent protruding pieces.
